(19) United States
(12) Patent Application Publication
(10) Pub. No.: US 2012/0056039 A1
(43) Pub. Date: Mar. 8, 2012

(54) CONTROL SYSTEM FOR AN AIRCRAFT

(75) Inventors: Matthias Stiefenhofer, Lindenberg (DE); Matthias Ludwig, Lindenberg (DE); Michael Rottach, Sulzberg (DE); Ralph Neumann, Scheidegg (DE); Manfred Schlosser, Lindenberg (DE)

(73) Assignee: Liebherr-Aerospace Lindenberg GmbH, Lindenberg (DE)

(21) Appl. No.: 13/218,660

(22) Filed: Aug. 26, 2011

(30) Foreign Application Priority Data
Aug. 30, 2010 (DE) 102010035822.3

(51) Int. Cl. B64C 13/12

(52) U.S. Cl. 244/229

(57) ABSTRACT

This invention relates to a control system for an aircraft consisting of at least two active inceptor units and at least one coupling means, wherein the coupling means generates or influences at least one setpoint for the control of at least one of the active inceptor units, wherein the generated setpoint corresponds to a movement setpoint for a movement controller.

### BACKGROUND OF THE INVENTION

This invention relates to a control system for an aircraft consisting of at least two active inceptor units and at least one coupling means.

Modern aircraft have a fully redundant control system for pilot and copilot. In this case it is expedient to install a connection or coupling between the two control units. This coupling synchronizes both control devices, so that at any time the other pilot gets a feedback on control inputs made. The synchronization should also avoid potential control conflicts between the coupled control devices.

The active inceptors used are known designs of the fly-by-wire system. In contrast to the classical control stick designs, in which the forces which act on the airplane during the flight are transmitted to the control unit in the form of resistance and deflection, there is no such feedback in conventional fly-by-wire systems. In particular in aviation engineering, a haptic transmission of information of the control system often is of great advantage for the pilot.

Active inceptors provide for simulating the occurring control forces and adapt the same to the respective flight situation, so as to achieve an optimum support of the pilot. The feedback for example is transmitted to the control device in the form of movements or signals, whereby an intuitive reaction of the pilot to the respective flight situation is facilitated. Furthermore, the pilot gets a precise feedback on the control inputs made by him. Even when using an electric control system, it is therefore possible for the pilot to feel the behavior of the airplane during the flight operation.

The simulation of the occurring control forces at the individual active inceptors also plays an essential role during coupling. For a realistic simulation of the occurring control forces it is expedient to consider the states of the individual active inceptors during the feel simulation.

### SUMMARY OF THE INVENTION

The object of the present invention consists in presenting an architecture for coupling at least two active inceptor units.

This object is solved by the control system for an aircraft according to the features herein. Further advantageous embodiments of the control system are subject-matter of the description herein.

Accordingly, a control system for an aircraft consists of at least two active inceptor units and at least one coupling means. In accordance with the invention, the coupling means generates or influences at least one setpoint for the control architecture of at least one of the active inceptor units. This setpoint serves for feel generation or for simulation of the occurring control forces at the active inceptor units of the control system. In accordance with the invention, generating or influencing the setpoint for the corresponding control unit of the active inceptor units is effected by means of the central coupling means, wherein generating the setpoint or influencing the setpoint generated by a further unit can be carried out in dependence on the data provided by the individual active inceptor units of the system.

In accordance with the invention, at least one active inceptor unit comprises at least one movement controller. The actuation of the actuators/control elements for generating the control forces acting on the active inceptor of the inceptor unit for feel generation is controlled by a control path which operates according to the principle of a movement control. Expediently, a movement setpoint can be generated by the coupling means or an already existing setpoint can be influenced by the coupling means, which setpoint can be forwarded to at least one movement controller of at least one of the active inceptor units.

Preferably, a corresponding setpoint is transmitted to each active inceptor unit. Particularly preferably, each inceptor unit includes at least one movement controller.

To observe the states of the individual inceptor units separate from each other, the coupling means for each of the active inceptor units expediently generates at least one individual setpoint, in particular an individual movement setpoint.

At least one, particularly preferably all coupled active inceptor units comprise at least one feel generating means, at least one controller, in particular movement controller, and at least one state variable detection means for measuring at least one state variable of the inceptor. This corresponds to the minimum system architecture for realizing an active inceptor unit.

The state variable detection means are designed as suitable sensors which measure the state of the inceptor or the inceptor actuators and communicate the measured values to the feel generating means. On the basis of the incoming state variables a corresponding data record is generated inside the feel generating means for feel generation. The used controller, in particular the movement controller, actuates the actuators or control elements of the inceptor in dependence on a corresponding setpoint, in order to generate a feel for the pilot at the inceptor.

It is conceivable that at least a part of the components of the active inceptor units is designed in united form. In particular the united partial component of the inceptor units can be integrated into the coupling means. What is found to be expedient is the design of a central feel generating means which is integrated into the coupling means. It is likewise conceivable that to each active inceptor unit one coupling unit each is assigned. The coupling units of the inceptor units are connected with each other, in order to exchange relevant data for generating or influencing the one or more setpoints with each other. Mutual monitoring likewise is possible. The combination of individual coupling units generally is referred to as coupling means.

Frequently, different task areas are assigned to the individual active inceptor units. It is imaginable that a first active control unit is assigned to the pilot of the aircraft, with a second active inceptor unit being assigned to the copilot. In this case, it is regarded as expedient that the coupling means provides for a prioritization of the active inceptor units. For example, the inceptor unit assigned to the pilot has a higher priority, so that the control inputs made therewith are given priority.

Advantageously, one or more inner and/or outer state variables of the inceptor units can be supplied to the coupling means. The inner state variables describe the state of the inceptor, i.e. for example the position, the acceleration and the speed with which the inceptor is moved. The outer state variables for example include signals of external units which are connected with the inceptor only indirectly or not at all. The same include for example the signals of an autopilot of the aircraft or the signals of external circuits, actuators, control elements or the like. Further possible external state variables for example describe the airspeed, the flight altitude or the flight position of the aircraft to be controlled.

An essential advantage of the invention results from the fact that the used coupling means can be deactivated at any time and the coupled active inceptor units can be operated independent of each other. In particular, a defective inceptor unit can be deactivated in a case of fault, wherein the remaining inceptor units nevertheless remain ready for operation and fully functional. Preferably, this design is used in redundantly configured control systems.

For intercommunication between the active inceptor units, a bus system advantageously is provided. In a central design of the coupling means a communication of the active inceptor units with the coupling means is effected via the bus system. In the case of a division of the coupling means into individual coupling units assigned to the coupled active inceptor units a direct communication is effected between the inceptor units and the coupling units, respectively.

### BRIEF DESCRIPTION OF THE DRAWINGS

Further advantages and details can be taken from the exemplary embodiment illustrated in the drawings, in which:

FIG. 1: shows a block circuit diagram of an active inceptor unit, and

FIG. 2: shows a control system with active inceptor units.

### DESCRIPTION OF THE PREFERRED EMBODIMENTS

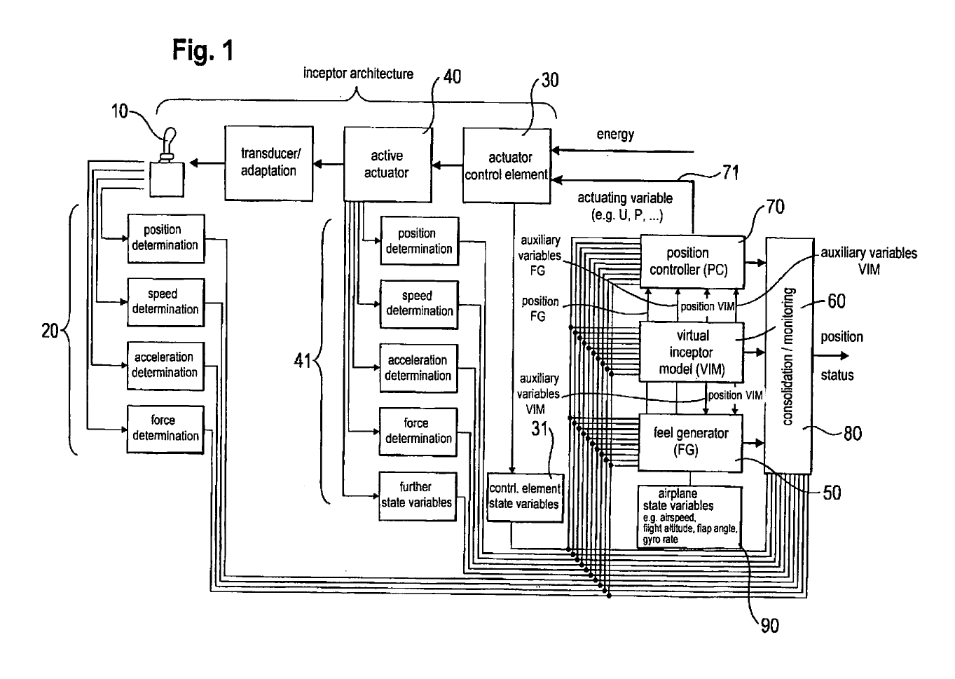

FIG. 1 shows a block circuit diagram of an active inceptor unit. The architecture comprises a mechanically movable inceptor in the form of a control stick 10 which is mechanically connected with at least one control element 30 or at least one active actuator 40. The actuator 40 preferably is designed as electric motor whose drive shaft causes a mechanical force acting on the control stick 10 via a transmission structure and generates a control stick movement. Since the control stick 10 is freely movable about an arbitrary number of axes, one control element 30 or actuator 40 is provided per axis.

The architecture furthermore comprises detection means 20 which are arranged at the stick mechanism and serve for determining the current actuating position of the control stick 10. Parameters such as the speed, the acceleration and the force, which act on the control stick 10 when the same is actuated, can be determined by these detection means 20. Further sensors determine the current state variables 31, 41 of the used actuators 40 or control elements 30 for actuating the control stick 10.

For generating the electronically controlled feedback in dependence on the control stick actuation the feel generating means 50 is used. At the input of the feel generating means 50 the signals of the internal state variables 20, 31, 41 generated by the sensors are present. Furthermore, the position controller 70 makes use of said signal lines of the sensors on the input side.

For considering the current flight position of the aircraft external state variables 90 furthermore are detected by external sensor systems and forwarded to the feel generating means 50. The external state variables 90 for example include the current airspeed, the flight altitude, the set flap angle and the measurement data of the gyroscopes used in the airplane and corresponding signals of the autopilot.

The virtual inceptor model 60 generally is based on a mathematical model which simulates a virtual control stick. In consideration of the incoming state variables 20, 31, 41 the inceptor model 60 generates a plurality of simulation values which comprise a virtual position as well as further auxiliary variables of the control stick 10. The simulation data are supplied to the position controller 70 and to the feel generating means 50. For example, an explicit measurement of certain state variables can be omitted, since the same can be calculated by means of the virtual inceptor model 60 in consideration of the incoming state variables 20, 31, 41.

By using the virtual inceptor model 60, a force measurement or a force control theoretically can be omitted completely.

From the supplied state variables 20, 31, 41 of the sensors, the virtual state and auxiliary variables of the virtual inceptor model 60 and the external state variables 90 the feel generating means 50 generates a desired position for the control stick 10. The desired position can be generated by using a stored characteristic curve or a feel model, wherein the characteristic curves or feel models can be assigned to different behavioral characteristics. By way of example the use of a spring-mass model or an arbitrary force-position characteristic curve should be mentioned, which in dependence on an incoming force state variable determines a predefined. desired position for the control stick 10. Further embodiments employ an attenuation speed characteristic curve or simulate a detent and/or break-out and/or position limitation and/or soft stop function and/or a friction model and/or a force or position offset and/or a force and/or speed limitation.

At the actual input of the position controller 70 the state variables 20, 31, 41 of the inceptor 10 and of the actuators 40 are present. Taking into account the desired position generated by the feel generating means 50 and taking into account the virtual auxiliary variables determined by the virtual inceptor model 60, a corresponding actuating variable 71 is generated for the control elements 30 of the inceptor architecture. The actuating variable 71 includes e.g. arbitrary control voltages, control currents as well as other control variables for the motor or control element actuation.

For safety reasons, the control stick system comprises a consolidation or monitoring means 80 which monitors the generated variables of the position controller 70 as well as the generated variables of the feel generating means 50 and of the virtual inceptor model 60 and possibly subjects the same to a plausibility check. The respective data of the monitoring or consolidation means 80 optionally are output acoustically via a display element or optically as status message.

Since an aircraft often is equipped with a plurality of inceptor units as shown in FIG. 1 for reasons of redundancy, a coupling must exist between the used systems. The communication between the units is realized by means of an electric signal connection. Status messages of the monitoring or consolidation means or the used state variables of the actuators or control elements and of the inceptors for example are exchanged between the control architectures of the coupled units.

Alternatively, a plurality of inceptors or inceptor units is used not for redundancy reasons, but instead for realizing various control tasks. For example, a side stick serves for executing a roll and pitch movement of a helicopter, whereas a second side stick controls the vertical movement. Here as well, a feel generation synchronized for both sticks as well as the exchange of various status messages and state variables is absolutely necessary.

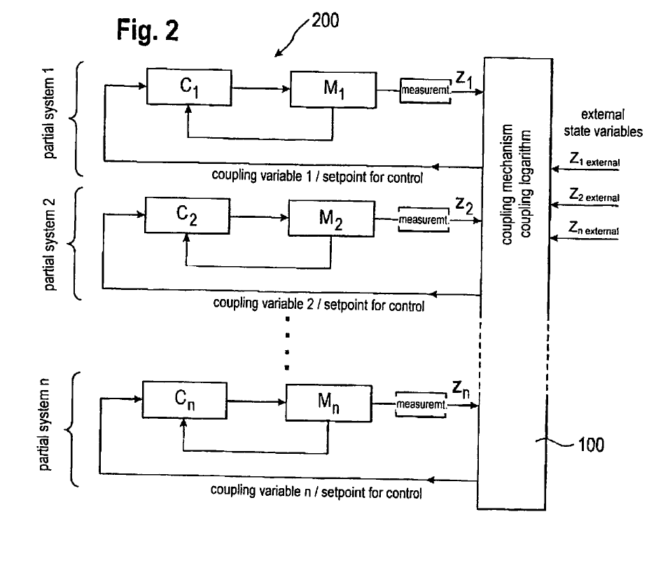

An example for the coupling of various active inceptor units according to the invention is shown in FIG. 2. The architecture 200 consists of a plurality of partial systems n, which are coupled with each other via the coupling mechanism 100. The individual partial systems 1 to n all are designed according to the exemplary embodiment of FIG. 1. The individual state variables Z₁ to Zₙ, which characterize the state of the respective inceptor of the partial systems 1 to n, are communicated to the coupling mechanism 100. Furthermore, the external state variables Z_{1 external} to Z_{n external}, which contain information of the autopilot and information on the current flight position of the aircraft, are communicated to the coupling mechanism.

On the basis of the supplied internal and external state variables, a tailored coupling variable/setpoint variable 1 to n is generated for each partial system 1 to n or an already existing state variable is influenced and supplied to the partial system 1 to n. In particular, the coupling variable or the setpoint is supplied to the respective control path of the partial systems 1 to n, wherein the control path is based on the principle of a position control, as has already been explained in detail in FIG. 1.

The control of the feel generation for each partial system 1 to n accordingly is effected in dependence on the state variables of the remaining partial systems 1 to n. The number of the coupled partial systems is not limited to an upper limit.

In principle, individual partial systems can be uncoupled or deactivated as desired, without impairing the total function of the control system 200.

An independent function of the individual partial systems 1 to n likewise is conceivable. Coupling therefore is effected only on demand. The individual partial systems 1 to n can be designed redundant to each other or also satisfy different task areas within the control system 200.

In the example of FIG. 2 an individual coupling mechanism is shown. In principle, the design of the control system 200 can be effected with a plurality of decentrally arranged coupling mechanisms. In this case, each partial system 1 to n includes its own coupling mechanism, wherein the same is connected with the partial systems 1 to n to be coupled via a bus system. This coupling can also be separated by the coupling mechanism at any time, so that each partial system operates separately.

1. A control system for an aircraft consisting of at least two active inceptor units and at least one coupling means, wherein the coupling means generates or influences at least one setpoint for the control of at least one of the active inceptor units, and the generated or influenced setpoint corresponds to a movement setpoint for a movement controller.

2. The control system according to claim 1, wherein for each of the active inceptor units at least one individual setpoint can be generated or influenced.

3. The control system according to claim 1, wherein at least one of the active inceptor units comprises at least one feel generator, at least one controller, in particular movement controller, and at least one state variable detection means for generating at least one state variable.

4. The control system according to claim 3, wherein at least a part of the components of the active inceptor units is united and in particular integrated into the coupling means.

5. The control system according to claim 1, wherein the coupling means provides for a prioritization of the active inceptor units.

6. The control system according to claim 1, wherein one or more partly different setpoint variables can be generated by the coupling means.

7. The control system according to claim 1, wherein one or more inner and/or outer state variables can be supplied to the coupling means, and the respective setpoint variable can be generated or influenced from one or more of these state variables.

8. The control system according to claim 1, wherein the coupling means can be deactivated at any time and the active inceptor units can be operated independently.

9. The control system according to claim 1, wherein a bus system is provided for the communication between the active inceptor units and the coupling means.

10. An aircraft with a control system according to claim 1.

11. The control system according to claim 2, wherein at least one of the active inceptor units comprises at least one feel generator, at least one controller, in particular movement controller, and at least one state variable detection means for generating at least one state variable.

12. The control system according to claim 11, wherein at least a part of the components of the active inceptor units is united and in particular integrated into the coupling means.

13. The control system according to claim 12, wherein the coupling means provides for a prioritization of the active inceptor units.

14. The control system according to claim 11, wherein the coupling means provides for a prioritization of the active inceptor units.

15. The control system according to claim 4, wherein the coupling means provides for a prioritization of the active inceptor units.

16. The control system according to claim 3, wherein the coupling means provides for a prioritization of the active inceptor units.

17. The control system according to claim 2, wherein the coupling means provides for a prioritization of the active inceptor units.

18. The control system according to claim 13, wherein one or more partly different setpoint variables can be generated by the coupling means.

19. The control system according to claim 14, wherein one or more partly different setpoint variables can be generated by the coupling means.

20. The control system according to claim 15, wherein one or more partly different setpoint variables can be generated by the coupling means.
